(19) United States
(12) Patent Application Publication
(10) Pub. No.: US 2010/0072182 A1
(43) Pub. Date: Mar. 25, 2010

(54) Fiber Laser Cutting Process with Multiple Foci

(75) Inventor: Charles L. Caristan, Houston, TX (US)

Correspondence Address: AIR LIQUIDE;Intellectual Property, 2700 POST OAK BOULEVARD, SUITE 1800, HOUSTON, TX, 77056, US

(73) Assignee: Air Liquide Industrial US LP, Houston, TX (US)

(21) Appl. No.: 12/237,478

(22) Filed: Sep. 25, 2008

(51) Int. Cl. B23K 26/00

(52) U.S. Cl. 219/121.72

(57) ABSTRACT

A process for laser cutting a workpiece comprising the steps of providing a fiber-type laser resonator; providing a workpiece to be cut having a thickness of at least 1 mm; generating a laser beam using the laser resonator; focusing the laser beam in several distinct focus points, at least one of said focus points being focused in the thickness of the workpiece to be cut; and cutting said workpiece at a speed of at least 20 m/min.

### FIELD OF THE INVENTION

The present invention relates to a fiber laser cutting process with multiple foci for laser cutting workpieces at high speed and having good quality.

### BACKGROUND OF THE INVENTION

High volume cutting of thin gage metals is predominantly done with mechanical press die-cutting tools operating at a very high number of hits per minute. This high volume cutting requires expensive dedicated cutting-tools. Moreover, with the development of new high strength alloys, mechanical cutting of thin gauge metals of such alloys results in edges of poor quality with excessive burrs and/or micro-cracks along the cut-edges.

Laser cutting can replace the mechanical cutting methods and achieve improved quality of the cut-edge and eliminated expensive cutting tools. However, the use of laser cutting is confronted with productivity and profitability challenges as the cutting speed slows down significantly when the thickness of the metals increases, especially when the thickness is greater than about 1 mm, preferably greater than about 1.3 mm. In this case, the cutting speed should be above 20 m/min Simply increasing the laser power increases the likelihood of focus shift due to thermal lensing which negatively alters the cutting performances.

U.S. Patent Publication No. 2007/119833 and U.S. Patent Publication No. 2007/119834 each disclose a laser cutting process of C—Mn steel or stainless steel using an ytterbium-doped fiber laser resonator that emits a laser beam with a wavelength of about 1.07 μm that is focused by a lens in a unique focal point located in the thickness of the workpiece. If workpieces having a thickness up to 30 mm can be cut with this process, the maximum cutting speed can be only of about 20 m/min.

Furthermore, the edge or cut quality thus obtained deteriorates rather quickly when the thickness of the material being cut is greater than about 2 mm to about 3 mm. More specifically, when the workpiece is made of a metal or a metal alloy, the surface of the cutting edges is not always smooth and adhering dross appear at the bottom of the cut.

Also, using a laser cutting process involving a fiber laser resonators and a standard focusing system, i.e., a lens or a mirror for focusing the laser beam on one focus point, can lead to other problems such as focus shift issues at high power, i.e., at 3 kW or above.

For these reasons, existing industrial laser cutting processes are commonly carried out using CO₂ laser resonators that usually give a good edge quality, i.e., a good surface smoothness and an absence of adherent dross at the bottom of the edge. For example, U.S. Pat. No. 6,175,096 discloses a method of processing a material, such as a metallic plate, with a laser beam generated by a CO₂ type laser resonator and subsequently focused by a multilens objective in several focal points that are spaced apart and used for cutting plates. The focal points are used for melting and cutting the plate material. As a result, a good cutting notch is obtained with good separation of the cut parts and poor adhesion of slag. However, using CO₂ laser resonators equipped with a multifocal lens has the drawbacks of requiring cleaning and maintenance of a beam delivery system comprising several optical elements, such as mirrors, windows and lenses, and a beam delivery conduit.

The problem to be solved is therefore to provide a laser cutting process that overcomes at least some of the above problems, in particular, a laser cutting process leading to a high speed cutting, typically of at least about 20 m/min, preferably of at least about 25 m/min, of metal pieces having a thickness of at least about 1 mm, preferably of at least about 1.3 mm, more preferably of at least about 1.5 mm, and, at the same time, providing a good cut quality.

### SUMMARY OF THE INVENTION

The present invention provides a laser cutting process wherein a laser beam emitted by a fiber laser resonator is focused in multiple foci that are used for cutting a workpiece, in particular a metal or metal alloy workpiece, thereby obtaining a high speed laser cutting with a good cut quality. The process for laser cutting a workpiece of the present invention comprises providing a fiber-type laser resonator; providing a workpiece to be cut having a thickness of at least about 1 mm; generating a laser beam of at least 0.3 kW using the laser resonator; focusing the laser beam in several distinct focus points, at least one of said focus points being focused in the thickness of the workpiece to be cut; and cutting said workpiece with said focused laser beam at a cutting speed of at least about 20 m/min.

### DETAILED DESCRIPTION OF THE INVENTION

The present invention provides for a process for laser cutting a workpiece. In the process of the present invention, the first step of the process is to provide a fiber-type laser resonator. According to process of the present invention, a fiber-type laser resonator or generator is used for emitting a laser beam having a wavelength of from between about 0.8 and about 1.3 μm, preferably of about 1.07 μm. In one preferred embodiment of the present process, the fiber-type laser resonator comprises one or several ytterbium-comprising fibers. In a still further embodiment, the fiber-type laser resonator generates a laser beam having a laser power of at least 1 kW, preferably greater than 2 kW, even more preferably at least 4 kW.

The second step of the process involves providing a workpiece to be cut, the workpiece having a thickness of at least 1 mm, preferably at least 1.3 mm. In a further embodiment of the present invention, the thickness of the workpiece is at least about 1.5 mm, preferably between about 1.5 mm and about 7 mm. In the process of the present invention, the workpiece to be laser cut in the present invention comprises a metal or a metal alloy. Preferably the metal or metal alloy is selected from steel, stainless steel, titanium, titanium alloy, nickel alloy, aluminum or aluminum alloy. While the process of the present invention can be used in a variety of situations, one particularly preferred use is for cutting workpieces that will become automotive body panels.

In one embodiment of the present invention, in the third step of the process a laser beam of at least 0.3 kW is generated using the laser resonator. In a preferred embodiment of the present invention, the laser power exceeds about 300 W, preferably there is an output power that exceeds about 2 kW, and more preferably an output power that exceeds about 4 kW.

As noted previously, at least one of the focus points is to be positioned in the thickness of the workpiece. In one preferred embodiment of the present invention, one of the focus points is positioned in the thickness of the workpiece. In a still further embodiment, two focus points are generated.

In another embodiment of the present invention, the focus points are focused by means of at least one optical lens. In an alternative embodiment, the focus points are focused by means of at least one optical mirror. Preferably a multifocal, such as a bifocal, focusing optical lens or an optical mirror is used for focusing the laser beam delivered by the laser resonator. The laser beam is immediately afterwards conveyed (transported) by an optical fiber from said resonator to a laser head that delivers the beam toward the workpiece to be cut.

The lens or mirror is typically arranged on the laser beam path either directly in the laser head or just before that laser head, i.e., between the end of the optical fiber that transports the laser beam and the workpiece. If a multifocal lens is used, it is preferably made of Zinc Sulfide (ZnS) material or of a fused silica material.

If a bifocal mirror is used in combination with a classical focusing lens, the traditional focusing lens can be made of fused silica, but will preferably be made of Zinc Sulfide. Alternatively, the focusing elements can be composed of several reflective optics and potentially no transmissive optics.

During the cutting step, the laser head delivering the laser beam toward the workpiece to be cut and said workpiece are moved relatively one with respect to the other. For example, the laser head can be fix and the workpiece mobile, for instance arranged on mobile holding means, such as a cutting table or similar device, or, in the opposite way, the laser head can be mobile, for instance arranged on a robotic arm or a motorized holding structure, and the workpiece fix. The motions of the laser head relative to the workpiece along the desired cutting trajectory are controlled by control means such as a CNC or similar means. Actually, the combination of a fiber laser resonator with a multifocal lens leads to an efficient cutting of workpieces having a thickness of at least about 1 mm at high speed, and preferably at least about 1.3 mm, and even more preferably at least about 1.5 mm, at speeds of at least about 20 m/min, and further to an unexpected good quality results in terms of edge smoothness and absence of dross. In the final step of the process, the workpiece is cut with the focused laser beam at a cutting speed of at least 20 m/min. In one embodiment of the present invention, the cutting speed is at least 23 m/min, preferably at least 24 m/min.

The process of the present invention may comprise a further step of providing an assist gas chosen from nitrogen, oxygen, argon, helium, hydrogen, CO₂ and mixtures thereof.

Other alternative embodiments of the process of the present invention include a process comprising providing a fiber-type laser resonator comprises one or several ytterbium-comprising fibers; providing a workpiece to be cut having a thickness of at least 1.3 mm; generating a laser beam having a laser power of at least 1 kW using the laser resonator; focusing the laser beam in two distinct focus points in the thickness of the workpiece to be cut; and cutting said workpiece with said focused laser beam at a cutting speed of at least 23 m/min.

A still further embodiment comprises providing a fiber-type laser resonator comprises one or several ytterbium-comprising fibers; providing a workpiece to be cut made of steel, stainless steel, titanium, titanium alloy, aluminum or aluminum alloy and having a thickness of at least 1.3 mm; generating a laser beam having a laser power of at least 2 kW and having a wavelength of from between 0.8 and 1.3 μm using the laser resonator; focusing by means of a ZnS-comprising lens, the laser beam in two distinct focus points, at least one of said focus points being focused in the thickness of the workpiece to be cut; and cutting said workpiece with said focused laser beam at a cutting speed of at least 23 m/min.

A final embodiment comprises providing a fiber-type laser resonator comprises one or several ytterbium-comprising fibers; providing a workpiece to be cut made of steel, stainless steel, titanium, titanium alloy, aluminum or aluminum alloy and having a thickness of at least 1.4 mm; generating a laser beam having a laser power of at least 2 kW and having a wavelength of about 1.07 μm using the laser resonator; focusing by means of a ZnS-comprising lens, the laser beam in two distinct focus points in the thickness of the workpiece to be cut; and cutting said workpiece with said focused laser beam at a cutting speed of at least 23 m/min.

### EXAMPLES

In order to show the efficiency of a process according to an embodiment of the present invention, 3 laser cutting tests were carried out. In the tests, 1.5 mm thick high strength steel pieces were cut according to the following conditions.

Test A (comparative example): a fiber-type laser resonator, such as for example an Ytterbium-fiber laser resonator, was used for delivering a 5 kW power laser beam (wave length=1.07 μm) which was focused in the thickness of the workpiece to be cut by a standard monofocal lens exhibiting a focal length (FL) of 143 mm.

Test B (comparative example): a CO₂-type laser resonator was used for delivering a 5 kW power laser beam which was focused in the thickness of the workpiece by a bifocal mirror in combination with a focusing lens of focal length (FL) of 127 mm.

Test C (according to the present invention): an ytterbium fiber-type laser resonator was used for delivering a 5 kW power laser beam (wavelength=1.07 μm) with a bifocal lens, i.e., a ZnS-type lens. The lens focused the laser beam in two distinct focus points located at about 8 mm one from the other (dF=8 mm), in the thickness of the material to be cut and along the pointing direction axis of the beam.

The cutting gas used during each of the tests was nitrogen.

The results are provided in the Table below.

When imposing a dross-free edge quality, the maximum cutting speed obtained according to prior processes (i.e., Tests A and B) was of about 22.5 m/min, beyond which, cutting still occurred but with dross formation. The severity of the dross formation increased with the cutting speed. In contrast, with the embodiment according to the present invention (Test C), a 20% higher cutting speed was reached, i.e. a cutting speed of about 27 m/min at equal or better edge quality.

TABLE

| | Maximum | |
|---|---|---|
| | Cutting | Dross-free |
| | Speed | Edge |
| | (m/min) | Quality |
| Test A | 22.5 | Yes |
| (comparative example) | | |
| Test B | 17.5 | Yes |
| (comparative example) | | |
| Test C | 27 | Yes |
| (embodiment according to | | |
| the present invention) | | |

FL: focal lens
dF: distance between the two focus points

Consequently, compared to cutting processes according to comparative Tests A and B, using a combination of a fiber-type laser resonator and a bifocal lens for carrying out a laser cutting process according to an embodiment of the present invention, can trickle down to a greater tolerance in focus positions relative to the material surface and thickness.

As a consequence, the cut edge quality is greatly enhanced, even when the cutting speed is increased about 20% and a cutting speed of 27 m/min can be obtained for a thickness of 1.5 mm.

By pairing focusing bifocal lenses with fiber laser technology it is possible to gain a significant cutting speed increase at improved cut-edge quality, and thus enhance the overall profitability of the cutting operation in production.

What is claimed is:

1. A process for laser cutting a workpiece, said process comprising the steps of:
a. providing a fiber-type laser resonator;
b. providing a workpiece to be cut having a thickness of at least 1 mm;
c. generating a laser beam of at least 0.3 kW using the laser resonator;
d. focusing the laser beam in several distinct focus points with at least one of said focus points being focused in the thickness of the workpiece to be cut;
e. cutting said workpiece with said focused laser beam at a cutting speed of at least 20 m/min.

2. The process of claim 1, wherein one of the focus points is positioned in the thickness of the workpiece.

3. The process of claim 1, wherein two focus points are generated and the workpiece is thicker than about 1.3 mm.

4. The process of claim 1, wherein the thickness of the workpiece is at least about 1.5 mm.

5. The process of claim 1, wherein the thickness of the workpiece is between 1.5 mm and 7 mm.

6. The process of claim 1, wherein the focus points are focused by means of at least one optical lens.

7. The process of claim 1, wherein the focus points are focused by means of at least one optical mirror.

8. The process of claim 1, wherein the fiber-type laser resonator comprises one or several ytterbium-comprising fibers.

9. The process of claim 1, wherein the fiber-type laser resonator generates a laser beam having a laser power of at least 1 kW.

10. The process of claim 1, wherein the fiber-type laser resonator generates a laser beam having a laser power greater than 2 kW.

11. The process of claim 1, wherein the fiber-type laser resonator generates a laser beam having a laser power of at least 4 kW.

12. The process of claim 1, wherein the fiber-type laser resonator generates a laser beam having a wavelength of between 0.8 and 1.3 μm.

13. The process of claim 1, wherein the fiber-type laser resonator generates a laser beam having a wavelength of about 1.07 μm.

14. The process of claim 1, wherein the workpiece comprises a metal or a metal alloy.

15. The process of claim 6, wherein the lens comprises zinc sulfide or fused silica.

16. The process of claim 7, wherein the lens comprises zinc sulfide or fused silica.

17. The process of claim 1, further comprising the step of providing an assist gas chosen from nitrogen, oxygen, argon, helium, hydrogen, CO₂ and mixtures thereof.

18. The process of claim 17, wherein the cutting speed is at least 23 m/min.

19. The process of claim 1, wherein the workpiece is to become part of an automotive body panel.

20. The process of claim 1, wherein the workpiece comprises steel, stainless steel, titanium, titanium alloy, nickel alloy, aluminum or aluminum alloy.

21. The process of claim 1, wherein the cutting speed is of at least 24 m/min.

22. A process for laser cutting a workpiece, said process comprising the steps of:
i. providing a fiber-type laser resonator comprises one or several ytterbium-comprising fibers;
ii. providing a workpiece to be cut having a thickness of at least 1.3 mm;
iii. generating a laser beam having a laser power of at least 1 kW using the laser resonator;
iv. focusing the laser beam in two distinct focus points in the thickness of the workpiece to be cut; and
v. cutting said workpiece with said focused laser beam at a cutting speed of at least 23 m/min.

23. The process of claim 22, wherein the workpiece to be cut has a thickness of at least 1.5 mm.

24. The process of claim 22, wherein the cutting speed is at least 24 m/min.

25. A process for laser cutting a workpiece, said process comprising the steps of:
i. providing a fiber-type laser resonator comprises one or several ytterbium-comprising fibers;
ii. providing a workpiece to be cut made of steel, stainless steel, titanium, titanium alloy, aluminum or aluminum alloy and having a thickness of at least 1.3 mm;
iii. generating a laser beam having a laser power of at least 2 kW and having a wavelength of from between 0.8 and 1.3 μm using the laser resonator;
iv. focusing by means of a ZnS-comprising lens, the laser beam in two distinct focus points, at least one of said focus points being focused in the thickness of the workpiece to be cut; and
v. cutting said workpiece with said focused laser beam at a cutting speed of at least 23 m/min.

26. The process of claim 25, wherein the workpiece to be cut has a thickness of at least 1.4 mm.

27. The process of claim 25, wherein the cutting speed of at least 24 m/min.

28. A process for laser cutting a workpiece, said process comprising the steps of:
i. providing a fiber-type laser resonator comprises one or several ytterbium comprising fibers;
ii. providing a workpiece to be cut made of steel, stainless steel, titanium, titanium alloy, aluminum or aluminum alloy and having a thickness of at least 1.4 mm;
iii. generating a laser beam having a laser power of at least 2 kW and having a wavelength of about 1.07 μm using the laser resonator;
iv. focusing by means of a ZnS-comprising lens, the laser beam in two distinct focus points in the thickness of the workpiece to be cut; and
v. cutting said workpiece with said focused laser beam at a cutting speed of at least 23 m/min.

29. The process of claim 28, wherein the workpiece to be cut has a thickness of at least 1.5 mm.

30. The process of claim 28, wherein the cutting speed of at least 24 m/min.
